(19) United States
(12) Patent Application Publication
(10) Pub. No.: US 2014/0334962 A1
(43) Pub. Date: Nov. 13, 2014

(54) Methods and devices for powdering NdFeB Rare Earth permanent magnetic alloy

(71) Applicant: SHENYANG GENERAL MAGNETIC CO., LTD., Shenyang (CN)

(72) Inventor: Baoyu Sun, Shenyang (CN)

(73) Assignee: SHENYANG GENERAL MAGNETIC CO., LTD.

(21) Appl. No.: 14/341,764

(22) Filed: Jul. 26, 2014

(30) Foreign Application Priority Data
May 11, 2014 (CN) 201410194940.9

(51) Int. Cl. H01F 41/02; B02C 23/12; B02C 19/06

(52) U.S. Cl. CPC H01F 41/0266; B02C 19/06; B02C 23/12; H01F 1/0571
USPC 419/28; 241/5; 241/39; 241/29

(57) ABSTRACT

A method of powdering NdFeB rare earth permanent magnetic alloy includes: adding mixed powder after a hydrogen pulverization into a grinder; grinding the powder with a high-speed gas flow ejected by a nozzle; sending the ground powder into a centrifugal sorting wheel with the gas flow; collecting, by a cyclone collector, fine power selected by the sorting wheel; collecting, by a post cyclone collector, the fine powder discharged out with the gas flow from a gas discharging pipe of the cyclone collector; introducing, by a depositing device, the fine powder collected by the cyclone collector and by the post cyclone collector into a depositing tank; compressing, by a compressor, and cooling, by a cooler, the gas discharged by the post cyclone collector; and then sending the gas into a gas inlet of the nozzle for recycling. A device thereof is also provided.

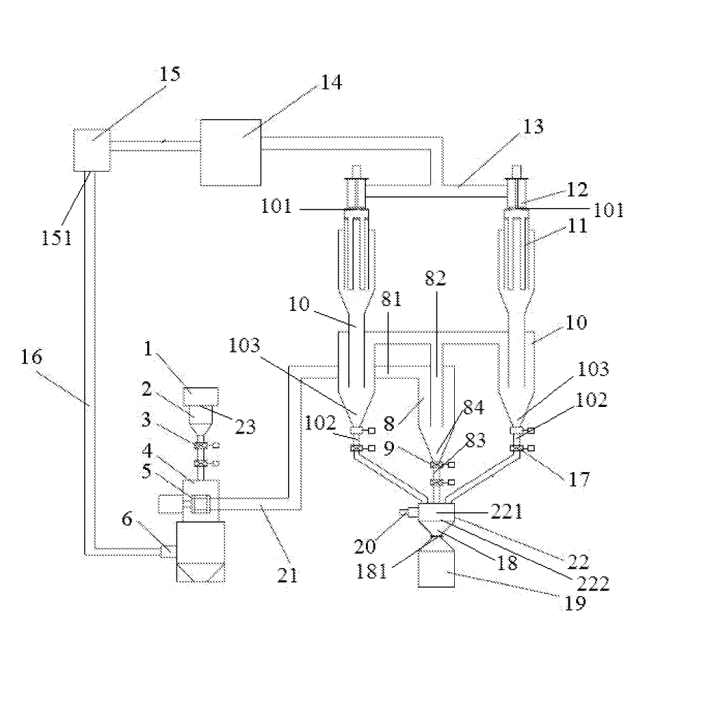

### CROSS REFERENCE OF RELATED APPLICATION

This application claims priority under 35 U.S.C. 119(a-d) to Chinese Patent Application No. 201410194940.9, filed May 11, 2014, which is incorporated herein by reference.

### BACKGROUND OF THE PRESENT INVENTION

1. Field of Invention

The present invention relates to permanent magnetic devices, and more particularly methods and devices for powdering the NdFeB rare earth permanent magnetic alloy.

2. Description of Related Arts

The NdFeB rare earth permanent magnetic alloy is increasingly applied because of its excellent magnetism, and widely applied in medical nuclear magnetic resonance imaging, computer hard disk drives, audio equipment and the mobile phones. Along with the benefits of energy-saving and low-carbon economy, the NdFeB rare earth permanent magnetic alloy is further applied in auto parts, household appliances, energy-saving control motors, hybrid power vehicles and wind generators.

In 1983, the Japanese patent applications, JP 1,622,492 and JP 2,137,496, initially disclosed the NdFeB rare earth permanent magnetic alloy of the Japan Sumitomo Special Metals Co., Ltd., wherein the features, the constituents and the preparation method of the NdFeB rare earth permanent magnetic alloy are disclosed; an Nd2Fe14B phase is shown as the main phase; and the grain boundary phase mainly comprises a rich Nd phase, a rich B phase and rare earth oxide impurities. Thereafter, the NdFeB rare earth permanent magnetic alloy has been widely applied because of its excellent magnetism, and has also been called the “permanent magnetism king.” In 1997, the Japan Sumitomo Special Metals Co., Ltd. was patented with U.S. Pat. No. 5,645,651, which further illustrated adding a Co element and a tetragonal structure to the main phase.

Along with the wide application of the NdFeB rare earth permanent magnets, the shortage of the rare earth is increasingly severe, especially the heavy rare earth elements which suffer from a resource shortage, so as to result in the continual rising of rare earth market price. Accordingly, many explorations were done by researchers, including double alloy technology, diffusion metalizing technology, grain boundary phase improvement or recombination technology.

Chinese patent application publication, CN101521069B, disclosed the NdFeB preparation technology via adding nano-particles of the heavy rare earth hydrides, the preparation method including the steps of: obtaining alloy flakes via strip casting, powdering through the hydrogen pulverization and the jet mill, then mixing the heavy rare earth hydride nano-particles which are prepared through the physical vapor deposition with the powder, and obtaining the NdFeB magnets through techniques such as compacting in the magnetic field and sintering. Although the NdFeB preparation method thereof improved the coercive force of the magnets, the mass production thereof still remains deficient.

Chinese patent publication, CN1272809C, disclosed a preparation method of the alloy powder of R—Fe—B series for a rare earth magnet, wherein the jet mill powdering technology includes the steps of: fine pulverizing the alloy via the high-speed gas flow of the inert gas having the oxygen content of 0.02%˜5%, eliminating the readily oxidized super-fine powder having the particle size smaller than 1 μm, and controlling the amount ratio of the super-fine powder to the whole powder below 10%. However, the preparation method and the devices thereof have low yield and waste expensive rare earth raw materials. By improving the structure of the device and the powder collecting system, and improving the powdering method and the preparation method of the NdFeB rare earth permanent magnet, the present invention reduces the amount of the super-fine powder, recycles the super-fine powder which was wasted in the Chinese patent publication CN1272809C, and avoids the waste of the rare earth in the Chinese patent publication CN1272809C.

### SUMMARY OF THE PRESENT INVENTION

An object of the present invention is to provide a powdering method and a device thereof which improves magnetism and reduces costs.

With the expansion in the application market of NdFeB rare earth permanent magnetic materials, the shortage of the rare earth resources is increasingly severe, especially in the fields of electronic components, energy-saving control electric motors, auto parts, new energy vehicles and wind power generation which needs relatively more heavy rare earth to improve the coercive force. Thus, reducing the usage of the rare earth, especially the usage of the heavy rare earth, is an important issue to be solved. Through applied effort, ingenuity, and innovation, the present invention provides a preparation method of a high-performance NdFeB rare earth permanent magnetic device.

Accordingly, in order to accomplish the above objects, the present invention adopts following technical solutions.

A method for powdering NdFeB rare earth permanent magnetic alloy, wherein a jet mill in a protection of nitrogen is provided for powdering, comprises steps of: mixing powder of NdFeB rare earth permanent magnetic alloy which is processed with a hydrogen pulverization to create a mixed powder; providing the mixed powder into a hopper of a feeder; feeding the mixed powder into a grinder (e.g., by the feeder);

grinding the mixed powder via a high-speed gas flow which is ejected by a nozzle of the grinder to create a ground powder; sending the ground powder into a centrifugal sorting wheel via the gas flow (e.g., to select the powder); sending rough powder (e.g., of the ground powder) beyond a required particle size to the grinder under a centrifugal force to continue grinding, and fine powder below the required particle size (e.g., of the ground powder) which are selected out by the centrifugal sorting wheel into a cyclone collector for collecting; receiving and collecting, by a post cyclone collector, the fine powder which are discharged out along with the gas flow from a gas discharging pipe of the cyclone collector; compressing, by a compressor, and cooling, by a cooler, the gas which is discharged from the post cyclone collector; and sending the compressed and cooled gas into an inlet pipe of the nozzle for recycling the nitrogen.

In some embodiments, the fine powder discharged along with the gas flow comprises a first portion of the ground powder below the required particle size; the fine powder collected by the cyclone collector comprises a second portion of the ground powder below the required particle size; and, the fine powder comprising the first portion of the ground powder which is discharged from the gas discharging pipe of the cyclone collector is received and collected by the post cyclone collector.

In some embodiments, the fine powder which is received and collected by the cyclone collector is collected into a powder mixer which is provided at a lower part of the cyclone collector, through a first valve which opens and closes alternatively; the fine powder which is received and collected by the post cyclone collector is also collected into the powder mixer which is provided at the lower part of the post cyclone collector, through a second valve which opens and closes alternatively; the fine powder is mixed within the powder mixer and then fed into a depositing tank.

In some embodiments, the fine powder is collected by the cyclone collector and the powder collected by the post cyclone collector is introduced into the depositing tank through a depositing device.

In some embodiments, the fine powder which is received and collected by the post cyclone collector is collected through between 2 and 6 post cyclone collectors which are connected in parallel.

For example, the fine powder which is received and collected by the post cyclone collector is collected through 4 post cyclone collectors which are connected in parallel.

A device for powdering NdFeB rare earth permanent magnetic alloy, comprises a jet mill in a protection of nitrogen which comprises a chopper, a feeder, a grinder having a nozzle and a centrifugal sorting wheel with blades, a cyclone collector, at least one post cyclone collector, a nitrogen compressor and a cooler, wherein the chopper is provided at an upper part of the feeder; the feeder is connected to the grinder via a valve; the nozzle and the centrifugal sorting wheel with blades are provided on the grinder; a gas outlet of the centrifugal sorting wheel is intercommunicated with a gas inlet of the cyclone collector through pipelines; a gas outlet of the cyclone collector is parallel connected with at least one post cyclone collector; each post cyclone collector has a filtering pipe; a gas outlet of each post cyclone collector is connected with a first end of a pneumatic valve; a second end of each pneumatic valve is connected with a discharging pipe which is further connected to a gas inlet of the nitrogen compressor; a gas outlet of the nitrogen compressor is connected to a gas inlet of the cooler; and a gas outlet of the cooler is connected to a gas inlet of the nozzle.

In some embodiments, the grinder has only one nozzle.

In some embodiments, the gas outlet of the cyclone collector is connected in parallel with between 2 and 6 post cyclone collectors; a discharging pipe of each post cyclone collector is connected to a gas inlet of the filtering pipe.

In some embodiments, the gas outlet of the cyclone collector is connected in parallel with 4 post cyclone collectors.

In some embodiments, a lower part of the cyclone collector has a first depositing mouth to which a first depositing device is connected; a lower part of the post cyclone collector has a second depositing mouth to which a second depositing device is connected.

In some embodiments, the first depositing mouth at the lower part of the cyclone collector is connected to the first depositing device through a first valve which opens and closes alternatively; the second depositing mouth at the lower part of the post cyclone collector is connected to the first depositing device through a second valve which opens and closes alternatively. A sampler is provided on the first depositing device; and a depositing tank is connected to a lower part of the first depositing device.

In some embodiments, the first depositing mouth at the lower part of the cyclone collector is connected to a powder mixer through a first valve which opens and closes alternatively; the second depositing mouth at the lower part of the post cyclone collector is connected to the powder mixer through a second valve which opens and closes alternatively. A stirring device is provided in the powder mixer; and a depositing tank is connected to a lower part of the powder mixer.

A method for preparing a NdFeB rare earth permanent magnet, comprises steps of: smelting an alloy of NdFeB rare earth permanent magnet into alloy flakes; processing the alloy flakes with a hydrogen pulverization and then adding the alloy flakes into a first mixing device for a pre-mixing to create a mixed alloy powder; providing the mixed alloy powder obtained from the hydrogen pulverization into a hopper of a feeder; providing the mixed alloy powder into a grinder and grinding the mixed alloy powder through a high-speed gas flow which is ejected by a nozzle of the grinder to create a ground powder; sending the ground powder into a centrifugal sorting wheel via the gas flow; sending rough powder beyond a required particle size to the grinder under a centrifugal force to continue grinding, and fine powder below the required particle size which are selected out by the centrifugal sorting wheel into a cyclone collector for collecting; receiving and collecting, by a post cyclone collector, the fine powder which are discharged out along with the gas flow from a gas discharging pipe of the cyclone collector; introducing the fine powder collected by the cyclone collector and the fine powder collected by the post cyclone collector into a depositing tank through a depositing device; after the depositing tank is filled with the fine powder, sending the fine powder into a second mixing device for post-mixing; then obtaining a NdFeB rare earth permanent magnet via compacting in a magnetic field, sintering in vacuum and processing with an aging treatment; and processing the permanent magnet into a rare earth permanent magnetic device with machining and a surface treatment.

In some embodiments, the pre-mixing comprises adding the alloy flakes after the hydrogen pulverization into the first mixing device, and adding at least one of an antioxidant and a lubricant during the pre-mixing.

In some embodiments, the pre-mixing comprises adding the alloy flakes after the hydrogen pulverization into the first mixing device, and adding micro powder of at least one oxide during the pre-mixing.

In some embodiments, the pre-mixing comprises adding the alloy flakes after the hydrogen pulverization into the first mixing device, and adding micro powder of at least one oxide selected from a group consisting of Y₂O₃, Al₂O₃ and Dy₂O₃ during the pre-mixing.

In some embodiments, the pre-mixing comprises adding the alloy flakes after the hydrogen pulverization into the first mixing device, and adding micro powder of Al₂O₃ the during pre-mixing.

In some embodiments, the pre-mixing comprises adding the alloy flakes after the hydrogen pulverization into the first mixing device, and adding micro powder of Dy₂O₃ during the pre-mixing.

In some embodiments, the pre-mixing comprises adding the alloy flakes after the hydrogen pulverization into the first mixing device, and adding micro powder of Y₂O₃ during the pre-mixing.

In some embodiments, the post-mixing comprises sending the fine powder into the second mixing device for post-mixing, which generates the fine powder having an average particle size of between 1.6 μm and 2.9 μm.

In some embodiments, the post-mixing comprises sending the fine powder into the second mixing device for post-mixing, which generates the fine powder having an average particle size of between 2.1 μm and 2.8 μm.

In some embodiments, the method further comprises steps of: smelting raw materials into the alloy and obtaining strip casting alloy flakes from the alloy, which comprises steps of: heating R—Fe—B-M raw materials up over 500° C. in vacuum; filling in argon, and continuing heating to melt and refine the R—Fe—B-M raw materials into a smelt alloy, wherein T₂O₃ micro powder is added to the R—Fe—B-M raw materials; thereafter, casting the smelt alloy liquid into a rotating roller with water quenching through an intermediate tundish, and obtaining the alloy flakes; wherein

R comprises at least one rare earth element, Nd;

M is one or more than one member selected from a group consisting of Al, Co, Nb, Ga, Zr, Cu, V, Ti, Cr, Ni and Hf;

T₂O₃ is one or more than one member selected from a group consisting of Dy₂O₃, Tb₂O₃, Ho₂O₃, Y₂O₃, Al₂O₃ and Ti₂O₃; and

an amount of the T₂O₃ micro powder is: 0≦T₂O₃≦2%.

Preferably, the amount of the T₂O₃ micro powder is: 0≦T₂O₃≦0.8%;

preferably, the T₂O₃ micro powder is at least one of Al₂O₃ and Dy₂O₃;

further preferably, the T₂O₃ micro powder is Al₂O₃; and

further preferably, the T₂O₃ micro powder is Dy₂O₃.

In some embodiments, smelting raw materials into the alloy and obtaining strip casting alloy flakes from the alloy, comprises steps of: heating R—Fe—B-M raw materials and T₂O₃ micro powder over 500° C. in vacuum; filling in argon, and continuing the heating to create a smelt alloy liquid; refining and then casting the smelt alloy liquid into a rotating roller with water quenching through an intermediate tundish; and obtaining the alloy flakes from the smelt alloy after quenching by the rotating roller.

In some embodiments, processing the alloy flakes with the hydrogen pulverization comprises steps of: providing the alloy flakes into a rotatable cylinder; vacuumizing, and then filling in hydrogen for the alloy flakes to absorb the hydrogen while controlling a hydrogen absorption temperature at 20° C.˜300° C.; rotating the rotatable cylinder while heating up and vacuumizing the alloy flakes to dehydrogenize, wherein a dehydrogenation heat preservation temperature is controlled at between 500 ° C. and 900° C. for between 3 hours and 15 hours; after heat preservation, cooling the rotatable cylinder by stopping the heating and removing a heating furnace, while continuing rotating the rotatable cylinder and vacuumizing; and when the temperature of the rotatable cylinder drops under 500° C., cooling by spraying water onto the cylinder.

In some embodiments, processing the alloy flakes with the hydrogen pulverization comprises steps of: providing a continuous hydrogen pulverization device; loading-rare earth permanent magnetic alloy flakes into a load box; passing the load box which is driven by a transmission device through a hydrogen absorption cavity, a heating and dehydrogenizing cavity and a cooling cavity of the continuous hydrogen pulverization device; receiving the load box by a discharging cavity through a discharging valve; pouring out the alloy flakes after the hydrogen pulverization into a storage tank at a lower part of the discharging cavity; sealing up the storage tank under a protection of nitrogen; moving the load box out through a discharging door of the discharging cavity and re-loading the load box for repeating the previous steps, wherein the hydrogen absorption cavity has a temperature controlled at between 50° C. and 350 ° C. for absorbing the hydrogen; the continuous hydrogen pulverization device comprises at least one heating and dehydrogenating cavity whose temperature is controlled at between 600° C. and 900° C. for dehydrogenating, and at least one cooling room.

In some embodiments, the continuous hydrogen pulverization device comprises two heating and dehydrogenating cavities, wherein the load box stays in the two heating and dehydrogenating cavities successively while staying in the respective heating and dehydrogenating cavity for between 2 hours and 6 hours; the continuous hydrogen pulverization device comprises two cooling cavities, wherein the load box stays in the two cooling cavities successively while staying in the respective cooling cavity for between 2 hours and 6 hours.

Preferably, a certain amount of hydrogen is filled in before heating and dehydrogenating is over.

In some embodiments, compacting in the magnetic field comprises steps of: loading the NdFeB rare earth permanent magnetic alloy powder into an alignment magnetic field compressor under a protection of nitrogen; under the protection of the nitrogen, in the alignment magnetic field compressor, sending the weighed load into a mold cavity of an assembled mold; then providing a seaming chuck into the mold cavity, and sending the mold into an alignment space of an electromagnet, wherein the alloy powder within the mold is processed with pressure adding and pressure holding, within the alignment magnetic field region; demagnetizing magnetic patches, and thereafter, resetting a hydraulic cylinder; sending the mold back to the powder loading position, opening the mold to retrieve the magnetic patch which is packaged with a plastic or rubber cover; then reassembling the mold and repeating the previous steps; putting the packaged magnetic patch into a load plate, and then extracting the packaged magnetic patch out of the alignment magnetic field compressor; and then, sending the extracted magnetic patch into an isostatic pressing device for isostatic pressing.

In some embodiments, compacting in the magnetic field comprises semi-automatically compacting in the magnetic field and automatically compacting in the magnetic field.

In some embodiments, semi-automatically compacting in the magnetic field comprises steps of: inter-communicating a storage tank filled with the NdFeB rare earth permanent magnetic alloy powder with a feeding inlet of an alignment magnetic field automatic compressor under the protection of nitrogen; thereafter, discharging air between the storage tank and a valve of the feeding inlet of a semi-automatic compressor; then opening the valve of the feeding inlet to introduce the powder within the storage tank into a hopper of a weighing batcher; after weighing, automatically sending the powder into a mold cavity by a powder sender; after removing the powder sender, moving an upper pressing tank of the compressor downward into the mold cavity for magnetizing and aligning the powder, wherein the powder is compressed and compacted in a magnetic field to form a compacted magnet patch; demagnetizing the compacted magnet patch, and then ejecting the compacted magnet patch out of the mold cavity; sending the compacted magnet patch into a load platform within the alignment magnetic field automatic compressor under the protection of nitrogen; packaging the compacted magnet patch with plastic or rubber cover via gloves to create a packaged magnet patch; sending the packaged magnet patch into the load plate for a batch output, and then isostatic pressing the packaged magnet patch by an isostatic pressing device.

In some embodiments, isostatic pressing the packaged magnet patch comprises sending the packaged magnet patch into a high-pressure cavity of the isostatic pressing device, wherein an internal space of the high-pressure cavity except the packaged magnet patch is full of hydraulic oil; sealing and then compressing the hydraulic oil within the high-pressure cavity, wherein the hydraulic oil is compressed with a pressure of between 150 MPa and 300 MPa; decompressing, and then extracting the magnet patch from the high-pressure cavity.

In some embodiments, the isostatic pressing device has two high-pressure cavities, wherein a first one is sleeved out of a second one, in such a manner that the second one is an inner cavity and the first one is an outer cavity. Isostatic pressing the packaged magnet patch comprises sending the packaged magnet patch into the inner cavity of the isostatic pressing device, wherein an internal space of the inner cavity except the package magnet patch is full of a liquid medium; and filling the outer cavity of the isostatic pressing device with the hydraulic oil, wherein the outer cavity is intercommunicated with a device for generating high pressure; a pressure of the hydraulic oil of the outer cavity is transmitted into the inner cavity via a separator between the inner cavity and the outer cavity, in such a manner that the pressure within the inner cavity increases accordingly; and the pressure within the inner cavity is between 150 MPa and 300 MPa.

In some embodiments, automatically compacting in the magnetic field comprises steps of: inter-communicating a storage tank filled with the NdFeB rare earth permanent magnetic alloy powder with a feeding inlet of an alignment magnetic field automatic compressor under the protection of nitrogen; thereafter, discharging air between the storage tank and a valve of the feeding inlet of the automatic compressor; then opening the valve of the feeding inlet to introduce the powder within the storage tank into a hopper of a weighing batcher; after weighing, automatically sending the powder into a mold cavity by a powder sender; after removing the powder sender, moving an upper pressing tank of the compressor downward into the mold cavity for magnetizing and aligning the powder, wherein the powder is compressed and compacted to form a compacted magnet patch; demagnetizing the compacted magnet patch, and then ejecting the compacted magnet patch out of the mold cavity; sending the compacted magnet patch into a load box of the alignment magnetic field automatic compressor under the protection of nitrogen; when the load box is full, closing the load box, and sending the load box into a load plate; when the load plate is full, opening a discharging valve of the alignment sealed magnetic field automatic compressor under the protection of nitrogen to transmit the load plate full of the load boxes into a transmission sealed box under the protection of nitrogen; and then, under the protection of nitrogen, intercommunicating the transmission sealed box with a protective feeding box of a vacuum sintering furnace to send the load plate full of the load boxes into the protective feeding box of the vacuum sintering furnace.

In some embodiments, the alignment magnetic field compressor under the protection of nitrogen has electromagnetic pole columns and magnetic field coils which are respectively provided with a cooling medium. The cooling medium can be water, oil or refrigerant; and during compacting, the electromagnetic pole columns and the magnetic field coils form a space for containing the mold at a temperature lower than 25° C.

Preferably, the cooling medium can be water, oil or refrigerant; and during compacting, the electromagnetic pole columns and the magnetic field coils form a space for containing the mold at a temperature lower than 5° C. and higher than −10° C.; and the powder is compressed and compacted at a pressure of between 100 MPa and 300 MPa.

In some embodiments, sintering the magnetic patch comprises steps of: under the protection of nitrogen, sending the magnet patch into a continuous vacuum sintering furnace for sintering; while driven by a transmission device, sending a load frame loaded with the magnet patch through a preparation cavity, a pre-heating and degreasing cavity, a first degassing cavity, a second degassing cavity, a pre-sintering cavity, a sintering cavity, an aging treatment cavity and a cooling cavity, respectively for removing organic impurities via pre-heating, heating to dehydrogenate and degas, pre-sintering, sintering, aging and cooling; after cooling, extracting the magnet patch out of the continuous vacuum sintering furnace and then sending the magnet patch into a vacuum aging treatment furnace for a second aging treatment, wherein the second aging treatment is executed at a temperature of betweem 450° C. and 650° C.; quenching the magnet patch after the second aging treatment, and obtaining the sintered NdFeB rare earth permanent magnet; and then, processing the sintered NdFeB rare earth permanent magnet into a NdFeB rare earth permanent magnetic device through machining and surface treatment.

In some embodiments, the load frame enters a loading cavity before entering the preparation cavity of the continuous vacuum sintering furnace; in the loading cavity, the magnet patch after isostatic pressing is de-packaged and loaded into the load box; further, the load box is loaded onto the load frame which is sent into the preparation cavity through the valve while driven by the transmission device.

In some embodiments, pre-sintering in vacuum comprises steps of: providing a continuous vacuum pre-sintering furnace; loading the load box which is filled with compacted magnet patches onto a sintering load frame; while driving by the transmission device, sending the sintering load frame orderly through a preparation cavity, a degreasing cavity, a first degassing cavity, a second degassing cavity, a third degassing cavity, a first pre-sintering cavity, a second pre-sintering cavity and a cooling cavity of the continuous vacuum pre-sintering furnace, respectively for pre-heating to degrease, heating to dehydrogenate and degas, pre-sintering and cooling, wherein argon is provided for cooling; after cooling, extracting the sintering load frame out of the continuous vacuum pre-sintering furnace, and then loading the load box onto an aging load frame; hanging up the aging load frame, and sending the hanging aging load frame through a pre-heating cavity, a heating cavity, a sintering cavity, a high-temperature aging cavity, pre-cooling cavity, a low-temperature aging cavity and a cooling cavity, respectively for sintering, aging at a high temperature, pre-cooling, aging at a low temperature and rapidly air-cooling.

In some embodiments, the sintering load frame is processed with pre-heating to degrease at between 200° C. and 400° C., heating to dehydrogenate and degas at between 400° C. and 900° C., pre-sintering at between 900° C. and 1050° C., sintering at between 1010° C. and 1085° C., aging at the high temperature of between 800° C. and 950° C., and then aging at the low temperature of between 450° C. and 650° C.; and after a thermal preservation, the sintering load frame is sent into the cooling cavity and then rapidly cooled with argon or nitrogen.

In some embodiments, the sintering load frame is processed with pre-heating to degrease at between 200° C. and 400° C., heating to dehydrogenate and degas at between 550° C. and 850° C., pre-sintering at between 960° C. and 1025° C., sintering at between 1030° C. and 1070° C., aging at the high temperature of between 860° C. and 940° C., and then aging at the low temperature of between 460° C. and 640° C.; and after a thermal preservation, the sintering load frame is sent into the cooling cavity and then rapidly cooled with argon or nitrogen.

In some embodiments, pre-sintering comprises pre-sintering in a vacuum degree higher than 5×10⁻¹ Pa; the step of sintering comprises sintering in a vacuum degree between 5×10⁻¹ Pa and 5×10⁻³ Pa.

Alternatively, the step of pre-sintering comprises pre-sintering in a vacuum degree higher than 5 Pa; the step of sintering comprises steps of: sintering in a vacuum degree between 500 Pa and 5000 Pa, and filling in argon.

In some embodiments, the sintering load frame has an effective width of between 400 mm and 800 mm; and the aging load frame has an effective width of between 300 mm and 400 mm.

In some embodiments, pre-sintering generates the magnet patch having a density of between 7.2 g/cm³ and 7.5 g/cm³; and the step of sintering generates the magnet patch having a density of between 7.5 g/cm³ and 7.7 g/cm³.

In some embodiments, the NdFeB permanent magnetic alloy comprises a main phase and a grain boundary phase. The main phase has a structure of R₂(Fe,Co)₁₄B, wherein a heavy rare earth HR content extending from an outer edge to one third of the phase is higher than the heavy rare earth HR content at a center of the main phase; the grain boundary phase has micro particles of Neodymium oxide; R comprises at least one rare earth element, Nd; HR comprises at least one member selected from a group consisting of Dy, Tb, Ho and Y.

In some embodiments, a metal phase of the NdFeB permanent magnetic alloy has a heavy rare earth content surrounding around R₂(Fe₁₋ₓCoₓ)₁₄B grains higher than a ZR₂(Fe₁₋ₓCoₓ)₁₄B phase of the R₂(Fe₁₋ₓCoₓ)₁₄B phase; no grain boundary phase exists between the ZR₂(Fe₁₋ₓCoₓ)₁₄B phase and the R₂(Fe₁₋ₓCoₓ)₁₄B phase; the ZR₂(Fe₁₋ₓCoₓ)₁₄B phases are connected through the grain boundary phase. ZR represents the rare earth of the phase whose heavy rare earth content in the grain phase is higher than a content of the heavy rare earth in an averaged rare earth content; 0≦x≦0.5.

In some embodiments, micro particles of Neodymium oxide are provided in the grain boundary phase at boundaries between the grains of at least two ZR₂(Fe₁₋ₓCoₓ)₁₄B phases of the metal phase of the NdFeB permanent magnetic alloy. An oxygen content of the grain boundary is higher than an oxygen content of the main phase.

In some embodiments, the grains of the NdFeB permanent magnetic alloy have a size of between 3 μm and 25 μm, such as between 5 μm and 15 μm.

These and other objectives, features, and advantages of the present invention will become apparent from the following detailed description, the accompanying drawings, and the appended claims.

### BRIEF DESCRIPTION OF THE DRAWINGS

The FIGURE is a sketch view of a powdering device of a jet mill under a protection of nitrogen according to a preferred embodiment of the present invention.

### DETAILED DESCRIPTION OF THE PREFERRED EMBODIMENT

In the FIGURE: 1-hopper; 2-feeder; 3-third valve; 4-grinder; 5-centrifugal sorting wheel; 6-nozzle; 7-pipeline; 8-cyclone collector; 9-first valve; 10-post cyclone collector; 11-filtering pipe; 12-peuamtic valve; 13-discharging pipe; 14-gas compressor; 15-gas cooler; 16-inlet pipe; 17-second valve; 18-depositing device; 19-depositing tank; 20-sampler; 21-gas outlet; 81-cyclone collector gas inlet; 82-cyclone collector gas outlet; 101-post cyclone collector gas outlet; 151-cooler outlet; 83-first depositing mouth; 102-second depositing mouth; 22-powder mixer; 221-stirring device; 84-lower portion of cyclone collector; 103-lower portion of post cyclone collector; 181-lower portion of depositing device; 222-lower portion of powder mixer; 23-upper portion of feeder.

As showed in the FIGURE, a device configured to powder NdFeB rare earth permanent magnetic alloy, comprising:

a grinder 4 comprising: a nozzle 6 configured to eject a gas to provide a gas flow for grinding powder of NdFeB rare earth permanent magnetic alloy; a centrifugal sorting wheel 5 and a gas outlet 21;

a cyclone collector 8 comprising: a cyclone collector gas inlet 81 connected to the gas outlet 21 of the centrifugal sorting wheel 5 to receive powder discharged with the gas from the grinder 4; a cyclone collector gas outlet 82 connected in parallel with two post cyclone collectors 10; each of the two post cyclone collectors 10 comprising: a filtering pipe 11 to separate the powder from the gas a after receiving the powder discharged with the gas from the cyclone collector; and a post cyclone collector gas outlet 101 to output the separated gas;

a gas compressor 14 connected with the post cyclone collector gas outlet 101 via a discharging pipe 13 to compress the separated gas; and

a gas cooler 15 connected with the gas compressor 14 to cool the separated gas, the gas cooler comprising a cooler outlet 151 connected to an inlet pipe 16 of the nozzle 6 for ejection of the separated gas by the nozzle 6 for grinding.

The cyclone collector 8 further comprises a first depositing mouth 83 at a lower portion 84 of the cyclone collector 8. Each of the two post cyclone collectors 10 comprises a second depositing mouth 102 at a lower portion 103 of each the post cyclone collectors 10.

The device further comprises a depositing device 18 connected to the first depositing mouth 83 of the cyclone collector 8 and the second depositing mouth 102 of the two post cyclone collectors 10 to receive the powder from the cyclone collector 8 and the two post cyclone collectors 10.

The device further comprises a depositing tank 19 connected to a lower portion 181 of the depositing device 18, wherein the depositing device 18 comprises a sampler 20.

The device further comprises: a powder mixer 22 which is connected to the first depositing mouth 83 through a first valve 9, and to the second depositing mouth 102 of each of the two post cyclone collectors 10 through two second valves 17, wherein the powder mixer 22 comprises a stirring device 221; and the depositing tank 19 is connected to a lower portion 222 of the powder mixer 22.

The device further comprises: a feeder 2 connected to the grinder 4 via a third valve 3, and a hopper 1 disposed at an upper portion 23 of the feeder 2.

The device further comprises two pneumatic valves 12 that open and close, each of the two pneumatic valves 12 connected between the post cyclone collector gas outlet 101 of each of the two post cyclone collectors 10 and the discharging pipe 13.

The present invention is further illustrated through following embodiments.

### EXAMPLE 1

600 Kg of an alloy having a component of Nd₃₀Dy₁Co_{1.2}Cu_{0.1}B_{0.9}Al_{0.1}Feᵣₑₛₜ was heated to melt, and then added with Dy₂O₃ micro powder. The alloy at a melt state was cast onto a rotating copper roller with water quenching, and cooled to form alloy flakes. A continuous vacuum hydrogen pulverization furnace was provided for a hydrogen pulverization, wherein the R—Fe—B-M alloy flakes were firstly loaded into a hanging load bucket, and then sent orderly into a hydrogen absorption cavity, a heating and dehydrogenating cavity and a cooling cavity, respectively for absorbing hydrogen, heating to dehydrogenate and cooling. Then, in a protective atmosphere, the alloy after the hydrogen pulverization was loaded into a storage tank and mixed. After mixing, according to Example 1 of the present invention, the mixture was powdered by a jet mill having two post cyclone collectors under a protection of nitrogen, wherein an atmosphere oxygen content of the jet mill was 0˜50 ppm. Powder collected by a cyclone collector and fine powder collected by the two post cyclone collectors were collected inside a depositing tank, next mixed by a mixing device under a protection of nitrogen, and then sent to be aligned and compacted by an alignment magnetic field compressor under the protection of nitrogen. A protective box having an oxygen content of 150 ppm, an alignment magnetic field intensity of 1.8 T, and a mold cavity inner temperature of 3° C. was provided. The compacted magnet patch had a size of 62 mm×52 mm×42 mm, and was aligned at a direction of 42 mm; the compacted magnet was sealed into the protective box. Then, the compacted magnet was extracted out of the protective box for an isostatic pressing at an isostatic pressure of 200 MPa; thereafter, a sintered NdFeB permanent magnet was obtained through sintering and an aging treament; the sintered NdFeB permanent magnet was machined into blocks of 50 mm×30 mm×20 mm; and the blocks are electroplated to form a rare earth permanent magnetic device. Table 1 shows test results of Example 1.

### EXAMPLE 2

600 Kg of an alloy having a component of Nd₃₀Dy₁Co_{1.2}Cu_{0.1}B_{0.9}Al_{0.1}Feᵣₑₛₜ was heated to melt. The alloy at a melt state was cast onto a rotating copper roller with water quenching, and cooled to form alloy flakes. A vacuum hydrogen pulverization furnace was provided for a hydrogen pulverization; thereafter, the pulverized alloy flakes were mixed while being added with micro powder of Y₂O₃ and a lubricant. After mixing, according to Example 2 of the present invention, the mixture was powdered by a jet mill having three post cyclone collectors under a protection of nitrogen, wherein an atmosphere oxygen content of the jet mill was 0˜40 ppm. Powder collected by a cyclone collector and fine powder collected by the three post cyclone collectors were collected inside a depositing tank, next mixed by a mixing device under a protection of nitrogen, and then sent to be aligned and compacted by an alignment magnetic field compressor under the protection of nitrogen. The compacted magnet patch had a size of 62 mm×52 mm×42 mm, and was aligned at a direction of 42 mm; the compacted magnet was sealed into a protective box. Then, the compacted magnet was extracted out of the protective box for an isostatic pressing; thereafter, a sintered NdFeB permanent magnet was obtained through sintering and an aging treatment; then the sintered NdFeB permanent magnet was machined into blocks of 50 mm×30 mm×20 mm; and then, the blocks are electroplated to form a rare earth permanent magnetic device. Table 1 shows test results of Example 2.

### EXAMPLE 3

600 Kg of an alloy having a component of Nd₃₀Dy₁Co_{1.2}Cu_{0.1}B_{0.9}Al_{0.1}Feᵣₑₛₜ was heated to melt. The alloy at a melt state was cast onto a rotating copper roller with water quenching, and cooled to form alloy flakes. A vacuum hydrogen pulverization furnace was provided for a hydrogen pulverization; thereafter, the pulverized alloy flakes were mixed while being added with micro powder of Al₂O₃. After mixing, according to Example 3 of the present invention, the mixture was powdered by a jet mill having four post cyclone collectors under a protection of nitrogen, wherein an atmosphere oxygen content of the jet mill was 0˜20 ppm. Powder collected by a cyclone collector and fine powder collected by the four post cyclone collectors were collected inside a depositing tank, next mixed by a mixing device under a protection of nitrogen, and then sent to be aligned and compacted by an alignment magnetic field compressor under the protection of nitrogen. The compacted magnet patch had a size of 62 mm×52 mm×42 mm, and was aligned at a direction of 42 mm; the compacted magnet was sealed into a protective box. Then, the compacted magnet was extracted out of the protective box for an isostatic pressing; thereafter, a sintered NdFeB permanent magnet was obtained through sintering and an aging treatment; then the sintered NdFeB permanent magnet was machined into blocks of 50 mm×30 mm×20 mm; and then, the blocks are electroplated to form a rare earth permanent magnetic device. Table 1 shows test results of Example 3.

### EXAMPLE 4

600 Kg of an alloy having a component of Nd₃₀Dy₁Co_{1.2}Cu_{0.1}B_{0.9}Al_{0.1}Feᵣₑₛₜ was heated to melt. The alloy at a melt state was cast onto a rotating copper roller with water quenching, and cooled to form alloy flakes. A vacuum hydrogen pulverization furnace was provided for a hydrogen pulverization; thereafter, the pulverized alloy flakes were mixed while being added with micro powder of Dy₂O₃. After mixing, according to Example 4 of the present invention, the mixture was powdered by a jet mill having five post cyclone collectors under a protection of nitrogen, wherein an atmosphere oxygen content of the jet mill was 0˜18 ppm. Powder collected by a cyclone collector and fine powder collected by the four post cyclone collectors were collected inside a depositing tank, next mixed by a mixing device under a protection of nitrogen, and then sent to be aligned and compacted by an alignment magnetic field compressor under the protection of nitrogen. The compacted magnet patch had a size of 62 mm×52 mm×42 mm, and was aligned at a direction of 42 mm; the compacted magnet was sealed into a protective box. Then, the compacted magnet was extracted out of the protective box for an isostatic pressing; thereafter, a sintered NdFeB permanent magnet was obtained through sintering and an aging treatment; then the sintered NdFeB permanent magnet was machined into blocks of 50 mm×30 mm×20 mm; and then, the blocks are electroplated to form a rare earth permanent magnetic device. Table 1 shows test results of Example 4.

### EXAMPLE 5

600 Kg of an alloy having a component of Nd₃₀Dy₁Co_{1.2}Cu_{0.1}B_{0.9}Al_{0.1}Feᵣₑₛₜ was heated to melt. The alloy at a melt state was cast onto a rotating copper roller with water quenching, and cooled to form alloy flakes. A vacuum hydrogen pulverization furnace was provided for a hydrogen pulverization; thereafter, according to Example 5 of the present invention, the pulverized alloy flakes was powdered by a jet mill having six post cyclone collectors under a protection of nitrogen, wherein an atmosphere oxygen content of the jet mill was 0˜20 ppm. Powder collected by a cyclone collector and fine powder collected by the four post cyclone collectors were collected inside a depositing tank, next mixed by a mixing device under a protection of nitrogen, and then sent to be aligned and compacted by an alignment magnetic field compressor under the protection of nitrogen. The compacted magnet patch had a size of 62 mm×52 mm×42 mm, and was aligned at a direction of 42 mm; the compacted magnet was sealed into a protective box. Then, the compacted magnet was extracted out of the protective box for an isostatic pressing; thereafter, a sintered NdFeB permanent magnet was obtained through sintering and an aging treatment; then the sintered NdFeB permanent magnet was machined into blocks of 50 mm×30 mm×20 mm; and then, the blocks are electroplated to form a rare earth permanent magnetic device. Table 1 shows test results of Example 5.

### Comparison Example

600 Kg of an alloy having a component of Nd₃₀Dy₁Co_{1.2}Cu_{0.1}B_{0.9}Al_{0.1}Feᵣₑₛₜ was heated to melt. The alloy at a melt state was cast onto a rotating quenching roller, and cooled to form alloy flakes. The alloy flakes were roughly pulverized by a vacuum hydrogen pulverization furnace, then processed by a conventional jet mill, and then sent to be aligned and compacted by an alignment magnetic field compressor under a protection of nitrogen. The compacted magnet patch had a size of 62 mm×52 mm×42 mm, and was aligned at a direction of 42 mm; the compacted magnet was sealed into a protective box. Then, the compacted magnet was extracted out of the protective box for an isostatic pressing at an isostatic pressure of 200 MPa; thereafter, a sintered NdFeB permanent magnet was obtained through sintering and an aging treatment; then the sintered NdFeB permanent magnet was machined into blocks of 50 mm×30 mm×20 mm; and then, the blocks are electroplated to form a rare earth permanent magnetic device.

TABLE 1
Performance Test Results of Examples and Comparison Example

| | | | | | Magnetic | |
|---|---|---|---|---|---|---|
| | | | | | energy | |
| | | Oxide | | | product | |
| | | micro | Magnetic | | (MGOe) + | |
| | | power | energy | Coercive | coercive | Weight- |
| | | content | product | force | force | lessness |
| Order | Number | (%) | (MGOe) | (KOe) | (KOe) | (g/cm³) |
| 1 | Example 1 | 0.1 | 48.8 | 23.4 | 72.2 | 4.2 |
| 2 | Example 2 | 0.2 | 48.2 | 24.2 | 72.4 | 3.2 |
| 3 | Example 3 | 0.3 | 47.8 | 22.8 | 70.6 | 2.8 |
| 4 | Example 4 | 0.1 | 48.6 | 23.1 | 71.7 | 3.5 |
| 5 | Example 5 | 0 | 48.3 | 22.6 | 70.9 | 3.8 |
| 6 | Compar- | 0 | 47.5 | 17.8 | 65.3 | 7.5 |
| | ison | | | | | |
| | example | | | | | |

By a comparison between the examples and the comparison example, the method and the device provided herein improves magnetism and corrosion resistance of the magnets.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, it is to be understood that the embodiments contemplated herein are not to be limited to the specific embodiments disclosed and that modifications and other embodiments are intended to be included within the scope of the appended claims.

What is claimed is:

1. A method for powdering NdFeB rare earth permanent magnetic alloy, comprising steps of:
sending mixed powder of NdFeB rare earth permanent magnetic alloy to a grinder;
grinding the mixed powder via a gas flow of gas which is ejected by a nozzle of the grinder to create a ground powder;
discharging fine powder along with the gas flow from the grinder, the fine powder discharged along with the gas flow comprising a first portion of the ground powder below a required particle size;
separating, by a filtering pipe, the fine powder and the gas from the fine powder discharged along with the gas flow;
providing the gas through a gas discharging pipe;
compressing, by a compressor, and cooling, by a cooler, the gas which is discharged from the gas discharging pipe; and
sending the compressed and cooled gas into an inlet pipe of the nozzle for recycling the gas.

2. The method, as recited in claim 1, further comprising steps of:
providing the ground powder along with the gas flow to a centrifugal sorting
providing rough powder beyond the required particle size back to the grinder under a centrifugal force to continue grinding, and fine powder which is selected out by the centrifugal sorting wheel into a cyclone collector for collecting, the cyclone collector comprising the gas discharging pipe and the fine powder collected by the cyclone collector comprising a second portion of the ground powder below the required particle size; and
receiving and collecting, by a post cyclone collector, the fine powder comprising the first portion of the ground powder which is discharged from the gas discharging pipe of the cyclone collector, the post cyclone collector including the filtering pipe.

3. The method, as recited in claim 2, further comprising steps of:
collecting, by a powder mixer which is provided at a lower part of the cyclone collector, the fine powder which is collected by the cyclone collector;
collecting, by the powder mixer, the fine powder which is collected by the post cyclone collector;
mixing the fine powder which is collected by the cyclone collector and the fine powder which is collected by the post cyclone collector by the powder mixer to create a mixed fine powder;
and sending the mixed fine powder into a depositing tank.

4. The method, as recited in claim 3, wherein:
collecting, by the powder mixer, the fine powder which is collected by the cyclone collector comprises passing the fine powder which is collected by the cyclone collector through a first valve that opens and closes alternatively; and
collecting, by the powder mixer, the fine powder which is collected by the post cyclone collector comprises passing the fine powder which is collected by the post cyclone collector through a second valve that opens and closes alternatively.

5. The method, as recited in claim 2, further comprising a step of: collecting, by between 2 and 6 post cyclone collectors which are connected in parallel, the fine powder comprising the first portion of the ground powder which is discharged from the gas discharging pipe of the cyclone collector.

6. The method, as recited in claim 5, wherein collecting the fine powder by between the 2 and 6 post cyclone collectors comprises collecting the fine powder by 4 post cyclone collectors.

7. The method, as recited in claim 1, further comprising steps of:
mixing powder of NdFeB rare earth permanent magnetic alloy which is processed with a hydrogen pulverization to create the mixed powder;
providing the mixed powder into a hopper of a feeder; and
sending, by the feeder, the mixed powder to the grinder.

8. A device configured to powder NdFeB rare earth permanent magnetic alloy, comprising:
a grinder comprising:
a nozzle configured to eject a gas to provide a gas flow for grinding powder of NdFeB rare earth permanent magnetic alloy;
a centrifugal sorting wheel and a gas outlet;
a cyclone collector comprising:
a cyclone collector gas inlet connected to the gas outlet of the centrifugal sorting wheel to receive powder discharged with the gas from the grinder;
a cyclone collector gas outlet connected in parallel with one or more post cyclone collectors;
the one or more one post cyclone collectors, each comprising:
a filtering pipe to separate the powder from the gas after receiving the powder discharged with the gas from the cyclone collector; and
a post cyclone collector gas outlet to output the separated gas;
a gas compressor connected with the post cyclone collector gas outlet via a discharging pipe to compress the separated gas; and
a gas cooler connected with the gas compressor to cool the separated gas, the gas cooler comprising a cooler outlet connected to an inlet pipe of the nozzle for ejection of the separated gas by the nozzle for grinding.

9. The device, as recited in claim 8, wherein the one or more post cyclone collectors comprise between 2 and 6 post cyclone collectors connected in parallel with the cyclone collector gas outlet, each post cyclone collector comprising the filtering pipe connected to the discharging pipe by the post cyclone collector gas outlet.

10. The device, as recited in claim 8, wherein:
the cyclone collector comprises a first depositing mouth at a lower portion of the cyclone collector; and
the one or more post cyclone collectors each comprise a second depositing mouth at a lower portion of the one or more post cyclone collectors; and
the apparatus further comprising one or more depositing devices connected to the first depositing mouth of the cyclone collector and second depositing mouth of the one or more post cyclone collectors to receive the powder from the cyclone collector and the at least one post cyclone collector.

11. The device, as recited in claim 10, further comprising a depositing tank connected to a lower portion of the one or more depositing devices; and wherein the one or more depositing device each comprise a sampler.

12. The device, as recited in claim 10, further comprising:
a powder mixer which is connected to the first depositing mouth through a first valve, and to the second depositing mouth of the one or more post cyclone collectors through the one or more second valves, wherein the powder mixer comprise a stirring device; and
a depositing tank connected to a lower portion of the powder mixer.

13. The device, as recited in claim 8, further comprising:
a feeder connected to the grinder via a valve, a hopper disposed at an upper portion of the feeder.

14. The device, as recited in claim 8, further comprising one or more pneumatic valves that open and close, each of the one or more pneumatic valves connected between the post cyclone collector gas outlet of one of the one or more post cyclone collectors and the discharging pipe.

15. A method for preparing a NdFeB rare earth permanent magnet, comprising steps of:
grinding mixed alloy powder of NdFeB rare earth permanent magnetic alloy by a gas flow which is ejected by a nozzle of a grinder to create a ground powder;
sending the ground powder into a centrifugal sorting wheel along with the gas flow;
sending rough powder beyond a required particle size back to the grinder under a centrifugal force to continue grinding, and fine powder below the required particle size which is selected out by the centrifugal sorting wheel into a cyclone collector for collecting;
receiving and collecting, by a post cyclone collector, the fine powder which is discharged out along with the gas flow from a gas discharging pipe of the cyclone collector;
introducing the fine powder collected by the cyclone collector and the fine powder collected by the post cyclone collector into a depositing tank through a depositing device;
obtaining a NdFeB rare earth permanent magnet from the fine powder by compacting in a magnetic field, sintering in vacuum and processing with an aging treatment; and
processing the permanent magnet into a rare earth permanent magnetic device with machining and a surface treatment.

16. The method, as recited in claim 15, further comprising steps of:
smelting the NdFeB rare earth permanent magnetic alloy and obtaining alloy flakes thereof;
processing the alloy flakes with a hydrogen pulverization;
adding the alloy flakes after the hydrogen pulverization into a mixer for pre-mixing to create a mixed alloy powder;
providing the mixed alloy powder after the hydrogen pulverization into a hopper of a feeder; and
providing the mixed alloy powder into the grinder by the feeder.

17. The method, as recited in claim 15, further comprising sending the fine powder from the depositing tank to a second mixer for post-mixing prior to obtaining the NdFeB rare earth permanent magnet from the fine powder.

18. The method, as recited in claim 17, further comprising obtaining post-mixed powder having an averaged particle size of between 1.6 and 2.9 μm by the post-mixing.

19. A method for making an R—Fe—B magnet, comprising steps of:
coarsely pulverizing an alloy; and
finely pulverizing the coarsely pulverized alloy such that particles 1 μm or less a re not removed.

20. The method, as recited in claim 15, wherein compacting in the magnetic field comprises steps of:
under protection of nitrogen, sending the fine powder into an alignment magnetic field compressor;
under the protection of nitrogen, aligning in the magnetic field and compacting through pressure;
packaging and extracting a packaged magnet out of the alignment magnetic field compressor in the protection of nitrogen;
sending the extracted magnet into an isostatic pressing device for isostatic pressing;
sending the packaged magnet into a nitrogen protective box and de-packaging the magnet in the protection of nitrogen; and
loading the de-packaged magnet into a sintering load box and sintering by a continuous vacuum sintering furnace.
